(19) United States
(12) Patent Application Publication
(10) Pub. No.: US 2013/0198128 A1
(43) Pub. Date: Aug. 1, 2013

(54) CONTEXT-AWARE APPARATUS AND METHOD FOR IMPROVING REASONING EFFICIENCY THEREOF

(71) Applicant: Su-Myeon KIM, Suwon-si (KR)

(72) Inventor: Su-Myeon KIM, Suwon-si (KR)

(21) Appl. No.: 13/555,237

(22) Filed: Jul. 23, 2012

(30) Foreign Application Priority Data
Feb. 1, 2012 (KR) 10-2012-0010347

(51) Int. Cl. G06N 5/02

(52) U.S. Cl. 706/47; 706/46

(57) ABSTRACT

Techniques for reasoning in a context-aware apparatus are provided. The context-aware apparatus includes least an input, an input selector, and a reasoning component. The information selector selects input information that satisfies a particular condition from among the information received by the input of the context-aware apparatus. The reasoning component performs context-aware reasoning based on the selected input information that satisfies the particular condition.

### CROSS-REFERENCE TO RELATED APPLICATION(S)

This application claims the benefit under 35 U.S.C. §119(a) of Korean Patent Application No. 10-2012-0010347, filed on Feb. 1, 2012, at the Korean Intellectual Property Office, the entire disclosure of which is incorporated herein by reference for all purposes.

### BACKGROUND

1. Field

The following description relates to context-aware technology.

2. Description of the Related Art

Reasoning efficiency is a critical factor for a context-aware system. Pieces of information necessary for contextual awareness are collected, and a present context is inferred from the collected information. However, reasoning for the inference is a process that generally requires a large amount of system resources. Therefore, the performance of a context-aware apparatus is closely related to the overall reasoning efficiency of the apparatus.

For a context-aware service, information about an environment surrounding a user may be continuously updated in real time through use of a combination of input and communication technology. Since a user's context is inferred each time a change occurs in the surrounding environment, the speed of any reasoning used to infer the context is important to implement a context-aware system that reacts in real time.

### SUMMARY

In one general aspect, a context-aware apparatus includes an information selector configured to select input information that satisfies a particular condition from among the received input information; and a reasoning component configured to perform context-aware reasoning based on the selected input information that satisfies the particular condition.

The context-aware apparatus also may includes a condition analyzer configured to generate selection condition information from reasoning rule information used by the reasoning component to perform the context aware reasoning, wherein the selection information configures the information selector to select the input information that satisfies the particular condition from among all received input information.

The context-aware apparatus also may include a rule information storage device configured to store the reasoning rule information that is read by condition analyzer to generate the selection condition information.

The context-aware apparatus also may include a rule information manager configured to set the reasoning rule information which is stored by the rule information storage device as the reasoning rule information.

The context-aware apparatus also may include a selection value integrator configured to, in response to a plurality of input information being selected that satisfies a particular condition by the information selector, integrate the selected input information into a single piece of information, and output the integrated information to the reasoning component.

The information selecting unit may include a semantic filter configured to filter out sensing information input from at least one sensor and select only sensing information that satisfies a particular condition. The condition analyzer may be configured to analyze a keyword included in the reasoning rule information and search for a sensor that indicates a subject matter of the input information, a property of the sensor, and at least one condition corresponding to the property. In addition, the condition analyzer may be configured to generate a selection condition table comprising the selection condition information, the selection condition table including a sensor corresponding to the keyword, the property of the sensor, and the at least one condition corresponding to the property.

In another general aspect, a method for reasoning in a context-aware apparatus including at least an input, an input selector, and a reasoning component, includes: selecting by the information selector input information that satisfies a particular condition from among the information received by the input of the context-aware apparatus; and performing context-aware reasoning by a reasoning component based on the selected input information that satisfies the particular condition.

The method may further include generating selection condition information from reasoning rule information used by the reasoning component to perform the context aware reasoning, wherein the selection information configures the information selector to select the input information that satisfies the particular condition from among all received input information.

The method may further include storing the reasoning rule information in a storage device. Storing the reasoning rule information may further include setting the reasoning rule information which is stored by the rule information storage device as the reasoning rule information.

The method may further include selecting by the information selector input information that satisfies a particular condition includes selecting a plurality of input information that satisfies a particular condition by the information selector. In addition, the selected input information may be integrated into a single piece of information and the integrated information may be output to the reasoning component.

Selecting information that satisfies a particular condition also may include filtering out sensing information input from at least one sensor to select only the sensing information that satisfies the particular condition.

Generating selection condition information from reasoning rule information also may include analyzing a keyword included in the reasoning rule information and searching for a sensor that indicates a subject matter of the input information, a property of the sensor, and at least one condition corresponding to the property. In addition, generating selection condition information from reasoning rule information also may include generating a selection condition table comprising the selection condition information, the selection condition table including a sensor corresponding to the keyword, the property of the sensor, and the at least one condition corresponding to the property.

According to the detailed description, context-aware reasoning is selectively performed based only upon the selected input information. Reasoning is executed only for the input information that satisfies a particular condition. Overloading of the reasoning component may be prevented since reasoning for needless information is not performed. As a result, efficiency of the reasoning may be improved.

Other features and aspects may be apparent from the following detailed description, the drawings, and the claims.

### BRIEF DESCRIPTION OF THE DRAWINGS

FIG. 1 is a diagram illustrating an example of a context-aware apparatus.

FIG. 2 is a diagram illustrating an example of non-selective reasoning using input information.

FIG. 3 is a diagram illustrating an example of selective reasoning in a context-aware apparatus.

FIG. 4 is a diagram illustrating an example of a selection condition table.

FIG. 5 is a diagram illustrating an example of selective reasoning performed by a context-aware apparatus for a plurality of input information.

FIG. 6 is a flowchart illustrating an example of a method of reasoning for a context-aware apparatus.

Throughout the drawings and the detailed description, unless otherwise described, the same drawing reference numerals refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Electronic devices have become increasingly intelligent by utilizing semantic technology. As a core element of intelligent services, research on intelligent processes has been conducted for context-aware systems taking advantage of semantic technology. In particular, semantic models that describe various situations by inferring additional information using a reasoning engine may be used. Using a semantic model for reasoning is advantageous because reasoning can still be performed when new sensing information is processed or when processing logic is changed (e.g., is added, deleted or otherwise adjusted) by changing only the semantic model without changing any hardware of an electronic device.

A typical example of a semantic model that may be used in context-aware applications is an ontology model. Context-aware logic may be easily represented using an ontology providing descriptive information about a surrounding environment. For example, concepts and/or definitions of a hot state and a cold state may be represented using an ontology defining “hot” as a state where a temperature sensor indicates a temperature greater than 10° C. and “cold” as a state where a temperature sensor indicates a temperature lower than 10° C. It is possible to determine whether a current state is hot or cold by reasoning based on the value of the temperature sensor in combination with the definition of hot and cold.

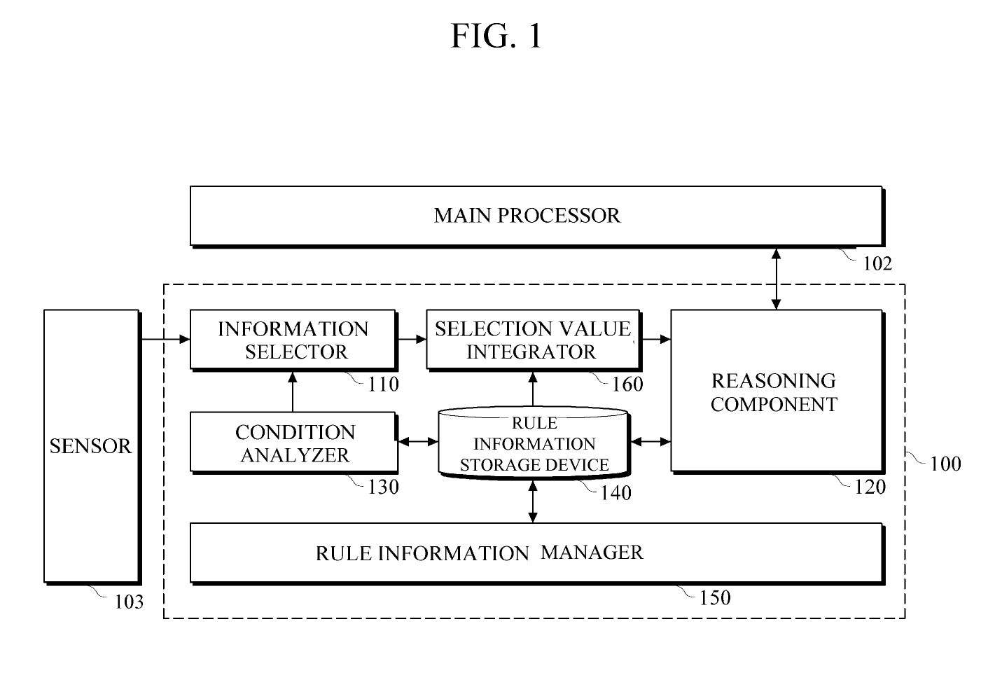

FIG. 1 is a block diagram illustrating an example of a context-aware system. Referring to FIG. 1, the context-aware system includes a context-aware apparatus 100, a main processor 102, and a sensor 103. The context-aware apparatus 100 includes an information selector 110 and a reasoning component 120. The context-aware apparatus may additionally include one or more of a condition analyzer 130, a rule information storage device 140, a rule information manager 150, and a selection value integrator 160.

As shown in FIG. 1, the context-aware apparatus 100 does not perform reasoning every time a change occurs in the information continuously received from at least one sensor 103 in response to a request from a main processor 200. Instead, reasoning is executed only when there is a likelihood of a particular change occurring in the surrounding environment such as, only when a particular condition is satisfied.

For example, as one example of an intelligent service, an air conditioner may be turned on if a room temperature exceeds 27° C. In this example, if reasoning is performed by checking the room temperature and the room temperature is lower than 27° C., unnecessary overhead is generated when the reasoning is continually executed for a temperature that does not require any reasoning to be made. Thus, unnecessary overhead can be prevented if the reasoning is performed only when the room temperature is above 27° C.

The context-aware apparatus 100 may include an information selector 110 and a reasoning component 120 to perform reasoning when changes can occur in the surrounding environment that would indicate reasoning is appropriate. In one example, reasoning component 120 performs reasoning only when a particular condition is satisfied.

The information selector 110 may reduce the amount of information input to the reasoning component 120 by selecting the input information that satisfies a particular condition from among the input information being continually received in real time. As shown in FIG. 1, for example, the input information is received in real time from at least one sensor 103, such as an accelerometer, a temperature sensor, a humidity sensor, or any other device capable of detecting and/or responding to physical stimuli and outputting information indicative of such detection. In addition, input information may be received by the information selector 110 in real time from other devices, a global positioning system (GPS), or wireless communications such as, Wi-Fi, or BlueTooth®.

In one example, the information selecting unit 110 may be implemented as a semantic filter configured to filter sensing information received from at least one sensor and select only the sensing information that satisfies a particular condition.

Overall reasoning is reduced because the reasoning component 120 infers a context based on the selected input information satisfying the particular condition. For example, the reasoning component 120 may be implemented to infer a context from input information selected to satisfy a particular condition using reasoning information derived from the rules providing context-aware reasoning as a source of the reasoning information. For example, the reasoning rule information may include information, such as a type of sensor that indicates the subject matter of the input information, a property of the input information, and at least one condition that is set regarding the sensor. The reasoning rule information is described in further detail below.

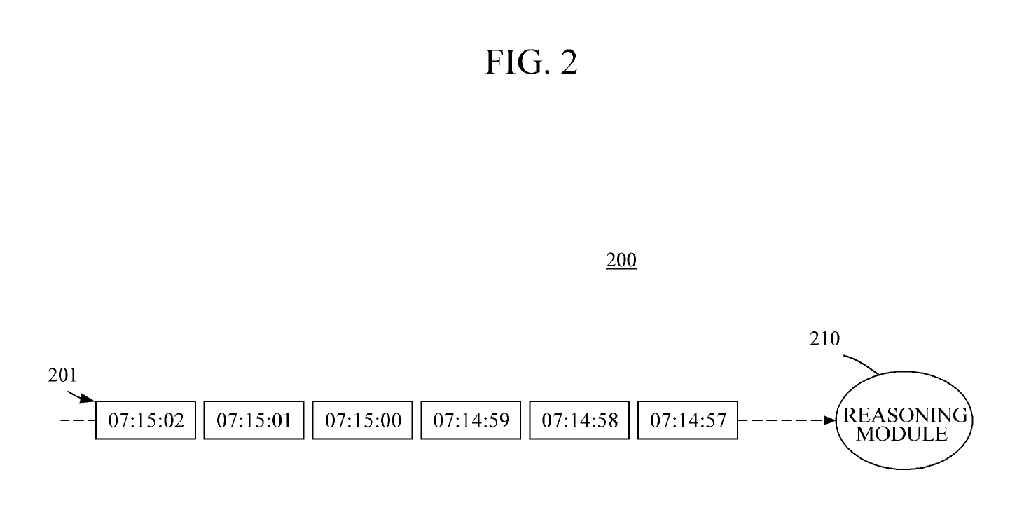

FIG. 2 is a diagram illustrating an example 200 of reasoning executed for all received input information. As shown in FIG. 2, time data 201 are input to a reasoning module 210. In this case, as the input information is received in real time, the information is input to the reasoning module 210. The reasoning module 210 implements a context-aware process by executing complicated reasoning procedures for each piece of information that is input to the module. In this example, needless reasoning is conducted because reasoning is performed for each piece of information received in real time (regardless of whether the reasoning is needed). As a result, the reasoning module 210 may be unnecessarily overloaded by reasoning performed on needless information.

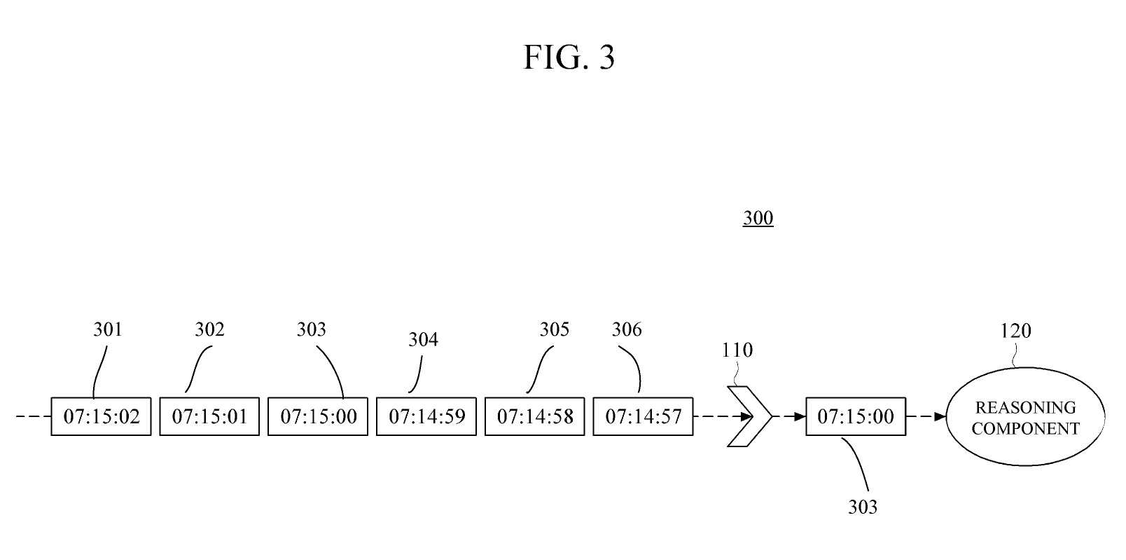

FIG. 3 is a diagram illustrating an example 300 of selective reasoning in a context-aware apparatus. As shown in FIG. 3, time data 301, 302, 303, 304, 305, and 306 are input to the information selector 110 in real time from a device (e.g., a sensor not shown). One piece of the time data 303 is input to the reasoning component 120. As a result, not all of the information that is received in real time is input to the reasoning component 120. Instead, only some of the information satisfying a particular condition is selected by the information selecting unit 110 and input to the reasoning performing unit 120. The context-aware reasoning is selectively performed based only upon the selected input information. Accordingly, reasoning is executed only for the input information satisfying a particular condition. Overloading of the reasoning component 120 is prevented since reasoning for needless information is not performed. As a result, efficiency of the reasoning is improved.

In another aspect, the context-aware apparatus 100 may further include a condition analyzer 130. The condition analyzer 130 generates condition information used to select the input information satisfying a particular condition from among all of the real time input information using the reasoning rule information as a reference. For example, the condition analyzer 130 may analyze a keyword of the reasoning rule information to search for a sensor that indicates the type of input information, a property of the input information, and at least one condition that applies to the sensor. In this example, the condition analyzing unit 130 generates the selection condition information in the form of a selection condition table that includes a sensor type or name, a property of the information provided by the sensor, and the at least one condition applied to the property.

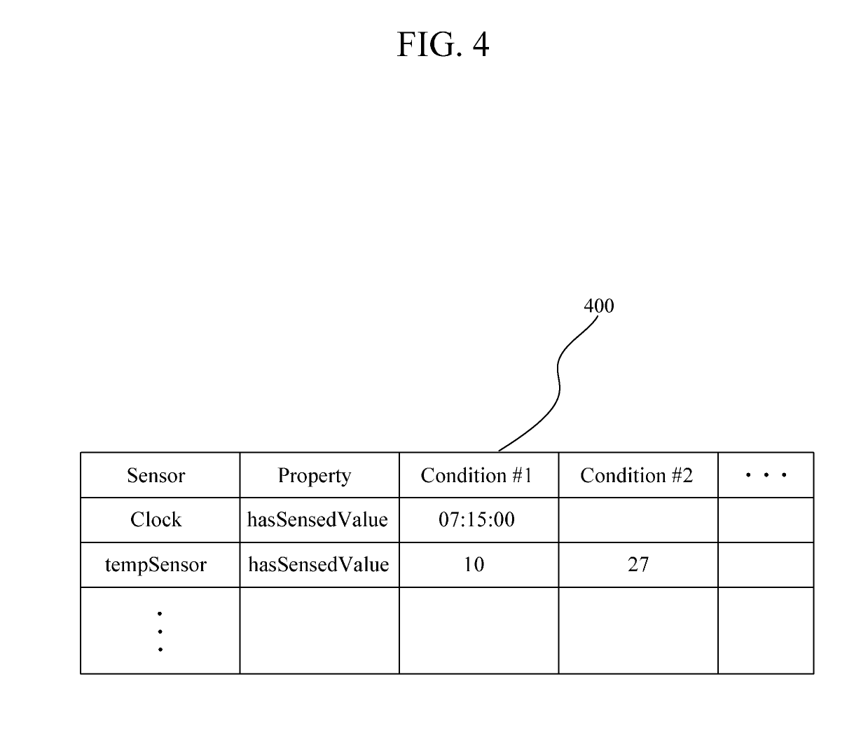

FIG. 4 is a diagram illustrating an example 400 of a selection condition table. In the table 400, the first column of the first row indicates that the sensor is a “Clock.” The second column of row 1 indicates that the input information is from a clock having a property “hasSensedValue” indicating a time value. Column three indicates an associated “condition #1” indicating a first time condition for a time value. The table is illustrative and may include more rows and columns. For example, “tempSensor” in the second row of the “sensor” column indicates that a the input information is from a temperature sensor having a property “hasSensedValue” indicating a temperature value, and an associated “condition #1” and “condition #2” indicating a first and second temperature conditions.

As mentioned above, the reasoning rule information provides rules that are used by the reasoning component 120 to provide context-aware reasoning for the context aware apparatus. The condition analyzer 130 performs keyword analysis on text of the rules forming the reasoning rule information to search for a sensor type or name that indicates the subject matter of input information, an associated property or value, and at least one condition associated with the sensor values. The condition analyzer 130 then records information for any found sensor and associated properties/conditions in the selection condition table.

For example, the reasoning rule information “(Clock hasSensedValue ?currentTime), (?currentTime equals “07:15:00”)→(Alarm isState “On”),” describes a rule that directs an alarm should be turned on at the time value 07:15:00. The condition analyzer 130 performing a keyword analysis of the text of the rule determines that the sensor is a clock with input information having a property of a time value, and a condition that the current time equals 7.15.00. The analyzer 130 generates the first row of the selection conditions table in FIG. 4 using this reasoning rule information.

Continuing with this example, the information selecting unit 110 filters out time information that is input before “07:15:00” with reference to the selection condition table, selects only time information that is received after “07:15:00,” and outputs the selected time information to the reasoning performing unit 120. Consequently, the reasoning component 120 does not receive time information or perform alarm context aware reasoning with reference to the reasoning rule information until after time 07:15:00 has occurred.

In another aspect, the context-aware apparatus 100 may further include a rule information storage device 140. The rule information storage 140 device is configured to store the reasoning rule information. As mentioned above, the reasoning rule information is information that specifies the rules that are used by the reasoning component 120 to perform context-aware reasoning on the selected input information and is also used as a source for generating selection condition information by the condition analyzer 130. In one example, the reasoning rule information may be implemented based on a semantic model stored in the rule information storage device 140.

In another aspect, the context-aware apparatus 100 may further include a rule information manager 150. The rule information manager 150 receives the reasoning rule information and stores the received reasoning rule information in the rule information storage unit 140. For example, the rule information manager 150 may provide a user interface configured to aid a user setting the reasoning rule information that specifies the rules used for context aware reasoning.

In another aspect, the context-aware apparatus 100 may further include a selection value integrator 160. The selection value integrator 160 integrates a plurality of selected input information that satisfies a particular condition into a single piece of integrated information that is output to the reasoning component 120.

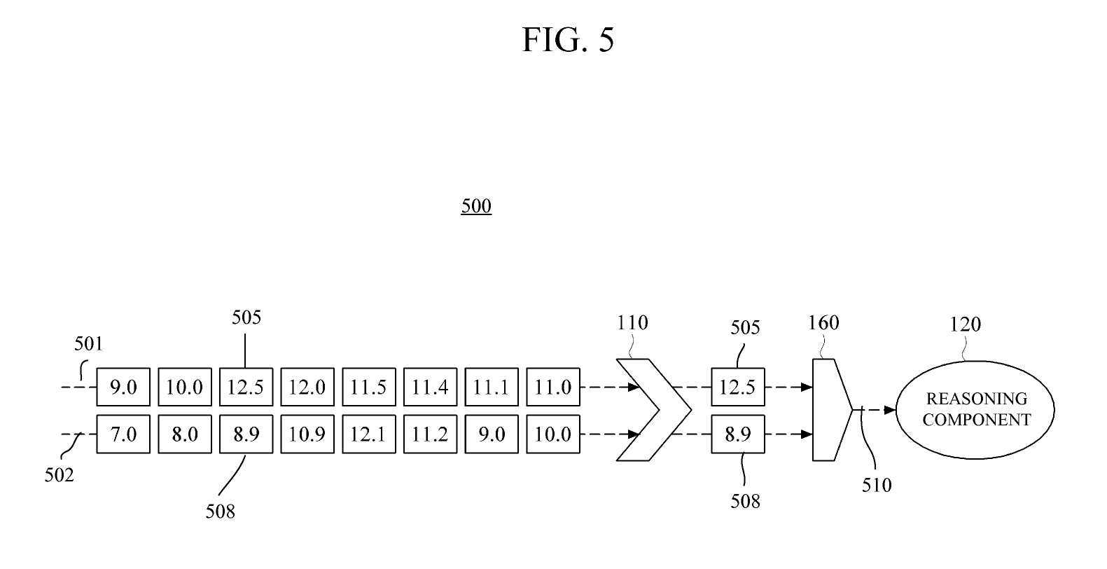

FIG. 5 is a diagram illustrating an example 500 of the selective reasoning executed by a context-aware apparatus for a plurality of selected input information. As shown in FIG. 5, input data streams 501 and 502 are input to the information selector 110. The input information selector 110 may select a plurality of input information 505 and 508 that satisfy a particular condition. For example, the plurality of input information may include multiple components, such as input corresponding to the simultaneous detection of acceleration in an x-direction and acceleration in a y-direction.

In this example, the information selector 110 selects the plurality of input information 505 and 508 that satisfy a particular condition. The selection value integrator 160 integrates the selected plurality of input information 505 and 508 into a single piece of integrated information 510 that is output to the reasoning component 120. The reasoning component 120 performs context aware reasoning using the received integrated input information 510.

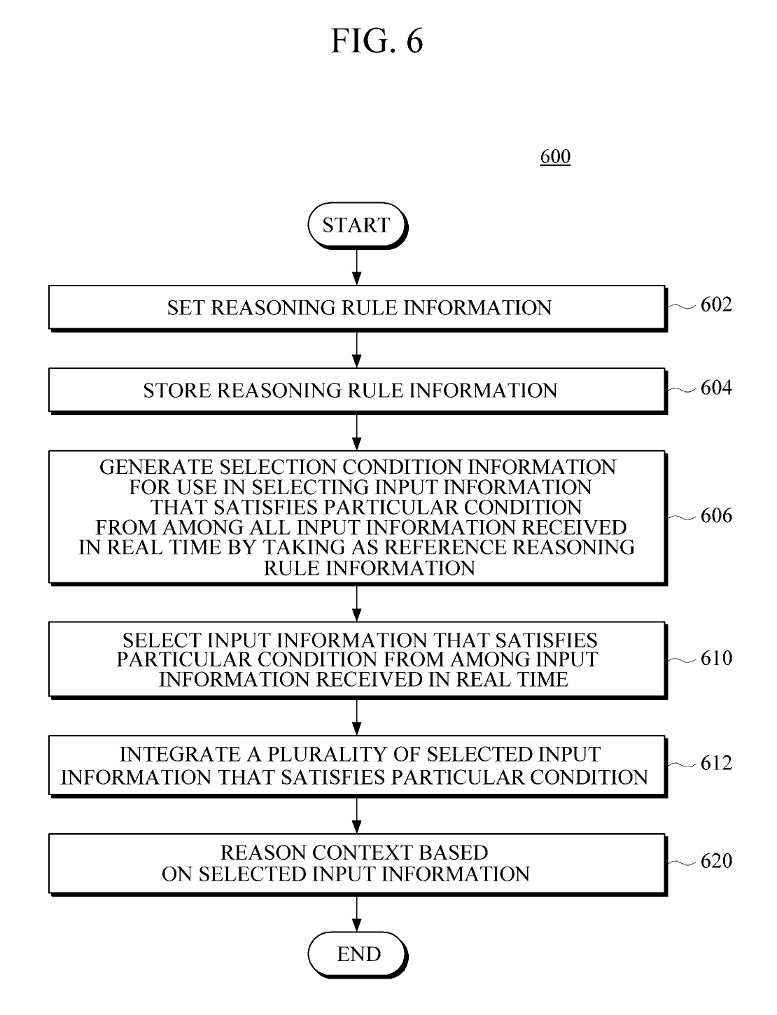

FIG. 6 is a flowchart illustrating an example 600 of a method for improving the efficiency of reasoning in a context-aware apparatus, such as, for example a context aware apparatus 100. Referring to FIG. 6, in operation 610, a context-aware apparatus selects input information that satisfies a particular condition from among the input information that is received in real time, thereby reducing the amount of input information for which reasoning is executed. For example, in operation 610, the context-aware apparatus may filter out sensing information input from at least one sensor to select only the sensing information that satisfies a particular condition.

Thereafter, in operation 620, the context-aware apparatus executes reasoning based on the selected input information that satisfies a particular condition, and the overall amount of reasoning necessary for a particular application is reduced. For example, the context-aware apparatus may perform reasoning in operation 620 that is based on the input information that satisfies a particular condition and was selected in operation 610 using reference reasoning rule information as a source that specifies the rules for reasoning.

The reasoning rule information may include information regarding a sensor that indicates the subject matter of the input information, a property of the input information, and at least one condition that applies to the sensor/input information. Accordingly, reasoning is not performed for all the input information received in real time. Instead, only some of the input information that satisfies a particular condition is provided for reasoning. Thus, needless reasoning on all information is prevented from occurring, and the reasoning efficiency of the context-aware apparatus is improved.

In operation 606, the context-aware apparatus generates selection condition information using the reasoning rule information to select input information from among all input information received in real time that satisfies a particular condition. For example, in operation 606, the context-aware apparatus may analyze a keyword included in the reasoning rule information and search for a corresponding sensor that indicates the subject matter of the input information, a property of the information, and at least one condition applied to the property.

The context-aware apparatus may generate a selection condition table to provide the selection condition information. The selection condition table includes a sensor corresponding to the keyword, a property of the information generated by the sensor, and at least one condition applied to the property. An example of the selection condition table is described in detail above.

The reasoning rule information specifies rules that are used as a source of information to implement context aware reasoning. In operation 606, the context-aware apparatus analyzes a keyword from the text of the rules included in the reasoning rule information. The context-aware apparatus searches for a sensor that matches otherwise corresponds to the keyword. The identified sensor indicates the subject matter of the input information, a property of the information, and at least one condition that applies to the input information. The context-aware apparatus records the identified sensor, property, and any conditions in the selection condition table.

In another aspect, in operation 604, the context-aware apparatus may store the reasoning rule information that is used as reference for generating the selection condition information and as information that specifies rules that are used as reference for context-aware reasoning. The reasoning rule information may be stored in operation 604 and may be used as reference for generating the selection condition information in operation 606. For example, the reasoning rule information may be implemented based on a semantic model and stored by the context aware apparatus.

In another aspect, in operation 602, the context-aware apparatus may receive the reasoning rule information. For example, in operation 602, the context-aware apparatus may provide a user with a user interface to set the reasoning rule information. The reasoning rule information set in operation 602 is stored in operation 604. The stored reasoning rule information is used as a reference for the context-aware reasoning in operation 620 and for generating the selection condition information in operation 606.

In another aspect, in operation 612, in response to selecting a plurality of input information that satisfies a particular condition, the context-aware apparatus may integrate the plurality of selected input information into a single, integrated piece of information and output the integrated information. For example, an acceleration sensor that simultaneously detects acceleration in an x-direction and acceleration in a y-direction may generate a plurality of input information. In this example, in operation 610, the plurality of input information that satisfies a particular condition may be selected, and in operation 612, the context-aware apparatus may integrate the selected input information into a single piece of information and output the integrated information. Then, in operation 620, the integrated information is analyzed to perform context aware reasoning.

As described above, the context-aware apparatus performs reasoning by selecting only input information that satisfies a particular condition from all of the input information that is continuously received so that an excessive overload can be reduced or prevented thereby improving context-aware performance of the apparatus.

One example of a context-aware apparatus 100 is shown in FIG. 1; however, it will be appreciated that this device is only exemplary and that any number of, types of, or configurations of different components and software may be incorporated into or omitted from the apparatus. For example, the context-aware apparatus may include a number of components including one or more of the following: one or more processing devices and one or more storage devices. The context-aware apparatus also may include additional elements, such as one or more communications interfaces, one or more input devices (e.g., a display, a keyboard, a key pad, a mouse, a pointer device, a trackball, a joystick, a touch screen, microphone, etc.), one or more output devices (e.g., speakers), a display, one or more interfaces, communications buses, controllers, removable storage devices. Additional elements not shown may include components of an optical reader (e.g., a bar code scanner or an infrared scanner), an RFID reader, and antennas/transmitters and/or transceiver. As is appreciated by those skilled in the art, any of these components (other than at least one processing device) may be included or omitted to create different configurations or types of context-aware devices, for example, to perform specific or specialized needs or tasks, generalized needs or multiuse tasks, or for various performance criteria, such as, mobility, speed, cost, efficiency, power consumption, and ease of use, among others.

The context-aware apparatus units described herein may be implemented using hardware components and software components and/or combinations. For example, the context-aware apparatus 100 may include one or more processing and storage devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor, or any other device capable of responding to and executing instructions in a defined manner. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors. As used herein, a processing device configured to implement a function A includes a processor programmed to run specific software. In addition, a processing device configured to implement a function A, a function B, and a function C may include configurations, such as, for example, a processor configured to implement both functions A, B, and C, a first processor configured to implement function A, and a second processor configured to implement functions B and C, a first processor to implement function A, a second processor configured to implement function B, and a third processor configured to implement function C, a first processor configured to implement functions A and B, and a second processor configured to implement function C, a first processor configured to implement functions A, B, C, and a second processor configured to implement functions A, B, and C, and so on.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums or storage devices. The computer readable storage medium may include any data storage device that can store data which can be thereafter read by a computer system or processing device. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. The methods and/or operations described above may be recorded, stored, or fixed in one or more computer-readable storage media that includes program instructions to be implemented by a computer to cause or configure a processor to execute or perform the program instructions when accessing or reading the program instructions.

Some of the described hardware devices or blocks of the diagrams may be configured to act as one or more software modules executed by one or more processing devices in order to perform the operations and methods described above. Also, functional programs, codes, and code segments for accomplishing the present invention can be easily construed and implemented by programmers skilled in the art to which this description pertains when provided the guidance of this description and its examples, the flow diagrams and block diagrams of the figures provided.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A context-aware apparatus comprising:
an information selector configured to select input information that satisfies a particular condition from among the received input information; and
a reasoning component configured to perform context-aware reasoning based on the selected input information that satisfies the particular condition.

2. The context-aware apparatus of claim 1, further comprising:
a condition analyzer configured to generate selection condition information from reasoning rule information used by the reasoning component to perform the context aware reasoning, wherein the selection information configures the information selector to select the input information that satisfies the particular condition from among all received input information.

3. The context-aware apparatus of claim 2, further comprising:
a rule information storage device configured to store the reasoning rule information that is read by condition analyzer to generate the selection condition information.

4. The context-aware apparatus of claim 3, further comprising:
a rule information manager configured to set the reasoning rule information which is stored by the rule information storage device as the reasoning rule information.

5. The context-aware apparatus of claim 1, further comprising:
a selection value integrator configured to, in response to a plurality of input information being selected that satisfies a particular condition by the information selector, integrate the selected input information into a single piece of information, and output the integrated information to the reasoning component.

6. The context-aware apparatus of claim 1, wherein the information selecting unit comprises a semantic filter configured to filter out sensing information input from at least one sensor and select only sensing information that satisfies a particular condition.

7. The context-aware apparatus of claim 2, wherein the condition analyzer is configured to analyze a keyword included in the reasoning rule information and search for a sensor that indicates a subject matter of the input information, a property of the sensor, and at least one condition corresponding to the property.

8. The context-aware apparatus of claim 7, wherein the condition analyzer is configured to generate a selection condition table comprising the selection condition information, the selection condition table including a sensor corresponding to the keyword, the property of the sensor, and the at least one condition corresponding to the property.

9. A method for reasoning in a context-aware apparatus including at least an input, an input selector, and a reasoning component, the method comprising:
selecting by the information selector input information that satisfies a particular condition from among the information received by the input of the context-aware apparatus; and
performing context-aware reasoning by a reasoning component based on the selected input information that satisfies the particular condition.

10. The method of claim 9, further comprising:
generating selection condition information from reasoning rule information used by the reasoning component to perform the context aware reasoning, wherein the selection information configures the information selector to select the input information that satisfies the particular condition from among all received input information.

11. The method of claim 10, further comprising:
storing the reasoning rule information in a storage device.

12. The method of claim 11, wherein storing the reasoning rule information further comprises setting the reasoning rule information which is stored by the rule information storage device as the reasoning rule information.

13. The method of claim 9, wherein selecting by the information selector input information that satisfies a particular condition includes selecting a plurality of input information that satisfies a particular condition by the information selector, and the method further comprises:
integrating the selected input information into a single piece of information; and
outputting the integrated information to the reasoning component.

14. The method of claim 9, wherein selecting by the information selector input information that satisfies a particular condition includes filtering out sensing information input from at least one sensor to select only the sensing information that satisfies the particular condition.

15. The method of claim 10, generating selection condition information from reasoning rule information includes analyzing a keyword included in the reasoning rule information and searching for a sensor that indicates a subject matter of the input information, a property of the sensor, and at least one condition corresponding to the property.

16. The method of claim 15, wherein generating selection condition information from reasoning rule information further includes generating a selection condition table comprising the selection condition information, the selection condition table including a sensor corresponding to the keyword, the property of the sensor, and the at least one condition corresponding to the property.
